(19) United States
(12) Patent Application Publication
(10) Pub. No.: US 2024/0250897 A1
(43) Pub. Date: Jul. 25, 2024

(54) METHOD FOR SIGNALING LINK OR NODE FAILURE IN A DIRECT INTERCONNECT NETWORK

(71) Applicant: Rockport Networks Inc., Ottawa (CA)

(72) Inventor: Dan OPREA, Kanata (CA)

(21) Appl. No.: 18/294,848

(22) PCT Filed: Aug. 5, 2022
(86) PCT No.: PCT/IB2022/000452

§ 371 Date: Feb. 2, 2024

Related U.S. Application Data
(60) Provisional application No. 63/229,567, filed on Aug. 5, 2021.

(51) Int. Cl. H04L 45/28; H04L 45/03

(52) U.S. Cl. CPC H04L 45/28; H04L 45/03

(57) ABSTRACT

Signaling link or node failure in a direct interconnect network may be facilitated by recording paths between the various nodes in the network in a lookup table. whereby the paths are represented by a sequence of exit port numbers for nodes along with a terminator marker indicating the end of the path and thus the destination node. Each path in the lookup table may also be associated with a status indicator. As packets are broken down into flits and sent over the network. failures in links or nodes may be detected. Once a failure is detected, a path failure flit is sent back through the path in reverse with path information to notify the source node of the failure. Once notified of a link or node failure. the associated path is updated to reflect its unavailability.

### FIELD OF THE INVENTION

The present invention relates to methods for signaling network status in a direct interconnect network. More particularly, the present invention relates to a method for the rapid signaling of network status back to source nodes in a direct interconnect network to support responses such as rapid path failover.

### BACKGROUND OF THE INVENTION

One method of distributing packets from a source node S to a destination node D involves the use of source routing, wherein the source node determines the entire path that a packet must follow to reach the destination node. In this respect, a head flit header in a packet may be populated with a series of node ports to use, which defines the path through the network. In the case where a single flow is distributed over multiple paths, as shown in FIG. 1 (which displays a set of possible paths to use in a direct interconnect network), such a path selection decision must be made for each packet.

U.S. Pat. Nos. 10,142,219 and 10,693,767 to Rockport Networks Inc., the disclosures of which are incorporated herein by reference, disclose methods of sending packets in a direct interconnect network from a source node S to a destination node D over multiple diverse paths. The packets are divided into flits, which may be sent over the network links using wormhole switching techniques, and may require re-ordering at the destination node D. More particularly, one of the disclosed methods comprises discovering all nodes and all output ports on each node in a network topology; including the discovered nodes and output ports in the network topology in a topology database in order to allow the nodes and ports to be included in shortest or disjoint path routing computations; calculating the shortest or disjoint paths from every output port on each node to every other node in the network topology based on those nodes and output ports contained in the topology database; generating a source routing database on each node containing the shortest or disjoint paths from every output port on each node to all other nodes in the network topology; receiving packets at the source node; sending the received packets to the output ports of the source node in a round robin, weighted round robin, random distribution or other calculated path selection process, whereby each of the received packets is thereafter segmented into flits at the output port of the source node and distributed along the shortest or disjoint path from the output port on the source node to the destination node using worm-hole switching, such that the packets are thereby distributed along alternate routes in the network topology; and re-assembling and re-ordering the packets at the destination node so that the packets accord with their original form and order.

FIG. 2 shows an example of a simple direct interconnect network with four nodes (A, B, C, and D). All links are point-to-point and using an arbitrary port assignment the nodes have been connected to form a two-dimensional torus. In general, a direct interconnect network might be formed with any arbitrary topology including well-known flattened butterfly or dragonfly networks as well as a torus. The paths to be calculated by the routing algorithm are a function of the topology and port assignments. In this example, using source routing represented as a list of output port numbers, possible paths from node A to node B include {3}, {0,3,3} and {2,3,1}.

PCT Application No. PCT/IB2022/000317 to Rockport Networks Inc., the disclosure of which is incorporated herein by reference, discloses methods of sending packets in a direct interconnect network from a source node S to a destination node D over multiple diverse paths, using control flits to relay backwards status information from destination node D to source node S.

The present invention seeks to expand or improve upon the various techniques disclosed in U.S. Pat. Nos. 10,142,219 and 10,693,767 and PCT Application No. PCT/IB2022/000317 by providing methods of routing control flits in a direct interconnect network that seek to provide one or more of the following advantages, namely: using control flits without packet data to distribute network status; using network status to provide rapid path switching under failure conditions; and providing an efficient method of generating reverse paths without requiring table lookups.

The techniques disclosed herein are intended to minimize packet loss by providing rapid failover to other paths upon link or node failure.

### SUMMARY OF THE INVENTION

In one embodiment, the present invention provides a method for signaling link or node failure to a source node when routing packets between the source node and a destination node in a direct interconnect network comprising the steps of: determining one or more paths between the source node and the destination node in the direct interconnect network and recording said paths in a path lookup table, said one or more paths in the path lookup table comprising a list of elements, namely a sequence of exit port numbers for nodes included in the one or more paths as well as a terminator marker indicating the end of the path to denote the destination node; providing a path status table that denotes, for each of the one or more paths in the path lookup table, whether said path is available or unavailable for routing packets between the source node and destination node; selecting a path denoted as available in the path status table in order to route a packet along said path between the source node and destination node; at the source node, formatting the packet into one or more flits, said one or more flits comprising a head flit that includes an amended list of elements for the selected path, said amended list of elements created by performing a shift and append function to the list of elements, wherein a first element from the list of elements denoting an exit port in the source node is removed and a unique source node marker is appended to an opposite end of the list of elements, commencing routing the one or more flits from the exit port in the source node to an input port in a next node along the selected path, namely from the exit port in the source node corresponding to the first element in the list of elements, at the next node along the selected path and upon receipt of the head flit, if the first element in the amended list of elements comprises an exit port number, then performing a shift and append function to the amended list of elements in the head flit, wherein the first element is removed from the amended list of elements and the input port to said next node is appended to the opposite end of the amended list of elements, and continuing routing the one or more flits from the exit port in said next node in accordance with the list of elements to a further next node in the selected path, and repeating step (vi), or if a link or node failure is detected, then generating a path failure flit to signal path failure back to the source node, said path failure flit including a source node pathway comprising a sequence of exit port numbers for nodes in the selected path back to the source node that is the amended list of elements in reverse, routing said path failure flit back to the source node, and updating the selected path in the path status table as unavailable, or if the first element in the amended list of elements comprises the terminator marker denoting the destination node, then processing the one or more flits.

In another embodiment, the present invention provides a direct interconnect network comprising a plurality of nodes, wherein one or more of said nodes comprise: a path lookup table comprising a list of paths to each destination node in the plurality of nodes, wherein the paths are represented as a sequence of exit port indicators for those nodes in each path in the list of paths; a path status table advising whether each path in the list of paths is available or unavailable for packet transmission; a path selection function for determining the path on which each packet will be sent, chosen from the available paths listed in the path status table; a packet to flit function for transforming each packet into one or more flits, said one or more flits comprising a head flit that includes the path to the destination node, said path being updatable during flit transmission to create a reverse path if needed upon link failure detection; a flit forwarding function for transmitting the one or more flits between nodes along the path to the destination node; output link failure detection for assessing whether flit transmission is possible from a given node in the path to the destination node; a path failure flit generator for creating a control flit to be transmitted to a source node using the reverse path upon link failure detection; a path failure flit extraction function to extract the destination node and path index information upon receipt of the control flit; and a path status update function to update the path status table as necessary.

The present invention may also provide wherein the paths are represented as the sequence of exit port indicators for those nodes in each path in the list of paths and a terminator marker indicating the end of the path to denote the destination node.

The present invention may also provide wherein the reverse path includes a sequence of input port numbers for nodes in the path to the destination node.

### BRIEF DESCRIPTION OF THE DRAWINGS

The embodiments of the invention will now be described, by way of example, with reference to the accompanying drawings in which:

FIG. 1 is a diagram showing example multipath flows from a source node S to a destination node D in a direct interconnect network;

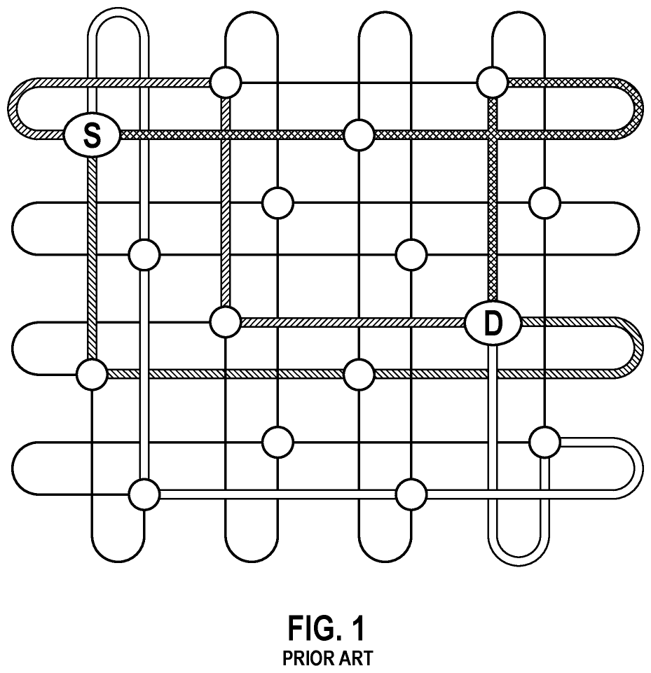

FIG. 2 is a diagram showing an example of a 4-node, two-dimensional torus to illustrate some arbitrary port numbering;

FIG. 3 is a diagram showing an embodiment of components and/or steps involved when sending a Head Flit (HF) and generating a Path Failure Flit (PFF) on a link failure in a direct interconnect network;

FIG. 4 is a diagram showing an example method of path rotation in a direct interconnect network;

FIG. 5 shows the Path Lookup Table and Path Status Table in source node S for the example in FIG. 4.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention seeks to address one or more issues that arise when there is a link or node failure in a direct interconnect network.

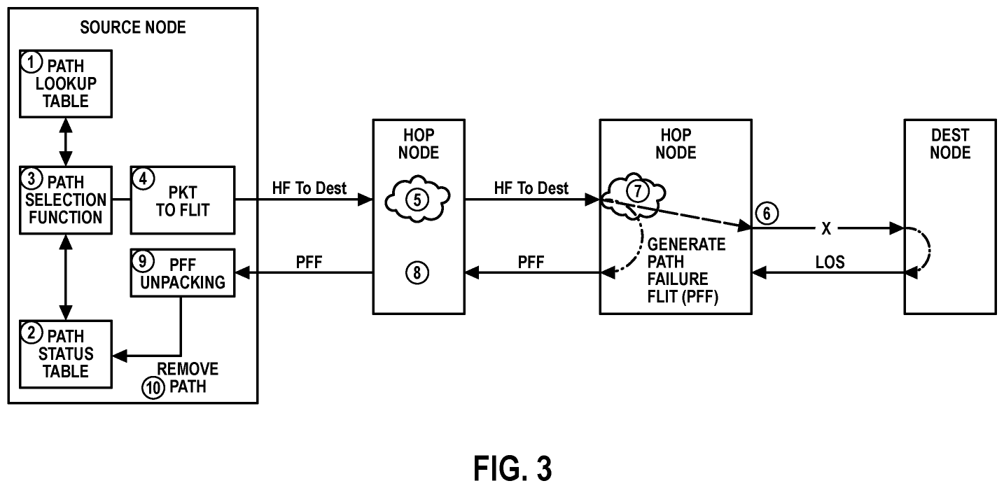

In one embodiment, the present invention provides methods to improve the implementation of rapid path switching in the event of a link or node failure. One such method can be described with reference to FIG. 3, which shows preferred functionality involved in an example multipath direct interconnect system, which in this example comprises, for ease of explanation, a single source node, a single destination node, and intermediate nodes therebetween that are capable of providing a variety of paths from source to destination. The well-known techniques of source routing and flit-based wormhole switching are employed. In this respect, with reference to FIG. 3, the following general components and/or functionality may be involved in a preferred method:

In the source node
1. A set of per-destination node state data including data in the form of a Path Lookup Table (PLT) which contains a list of available paths to each destination node, each path being computed using a technique known to persons skilled in the art, or as described in U.S. Pat. Nos. 10,142,219 and 10,693,767 and PCT Application No. PCT/IB2022/000317, for example. Each path may be represented as a sequence of exit port numbers with a terminator value indicating the end of the list (thereby denoting the end of the path/destination node);
2. Additional per-destination node state data in the form of a Path Status Table (PST), providing per destination node, the known status (available/invalid) of each available path as listed in the PLT. The implementation of the PLT and PST may be combined in the same table or in separate memory tables (as per the example provided herein);
3. A path selection function that will determine the path on which each packet will be sent, chosen from the available paths as currently represented in the PST using any known technique, as would be known by persons skilled in the art;
4. Functionality to format the packet to be sent into one or more flits, the head flit (HF) of which may contain additional metadata including but not limited to:
   The destination node number;
   A path index number to designate which of the available paths is being used, as indexed in the PST and PLT; and
   A set of port numbers representing the path to the destination, as read from the PLT, terminated by a unique marker indicating the destination node in the path.
      In the intermediate nodes
5. Flit forwarding functionality within the intermediate nodes connected in the network topology, which provides a multitude of possible paths from the source node to destination node. At each node the next hop port is taken from the path list, and then the path is processed using a method as described below;
   In the node experiencing a link failure
6. Functionality to detect the failure of an output link, using any well-known technique such as Loss of Signal (LOS), framing errors or excessive CRC errors, as known to persons skilled in the art;
7. Functionality to generate new Path Failure Flits (PFF) to signal to the source node that a path has failed. These PFF take the form of control flits that carry only control metadata and not normal traffic. A reverse path back to the source node is constructed using the path as reversed from the original packet head flit (HF), as described below. The PFF comprises metadata including the destination node and the path index;
   In the intermediate nodes
8. Functionality to send/carry the PFF back towards the source node. To speed up response time and minimize packet loss, these PFF control flits may be denoted as having a higher priority and taking precedence over other traffic passed in the intermediate nodes; and
   In the source node
9. Functionality to unpack the PFF and extract the destination node and path index information.
10. Functionality to update an entry in the Path Status Table (PST) by changing the path status to invalid. This may take the form of a read-modify-write update performed by the hardware to the table. This update will prevent the failed path from being selected when the PST is read for each packet.

A person skilled in the art would appreciate that the general components and/or functionality described above may be contained in each node, as nodes may act as a source, intermediate, or destination node for network communications in a direct interconnect network. The above-described mechanisms and functionality is capable of rapidly removing paths with link or node failure from further selection and thereby minimizing packet loss when using source routing in a direct interconnect network.

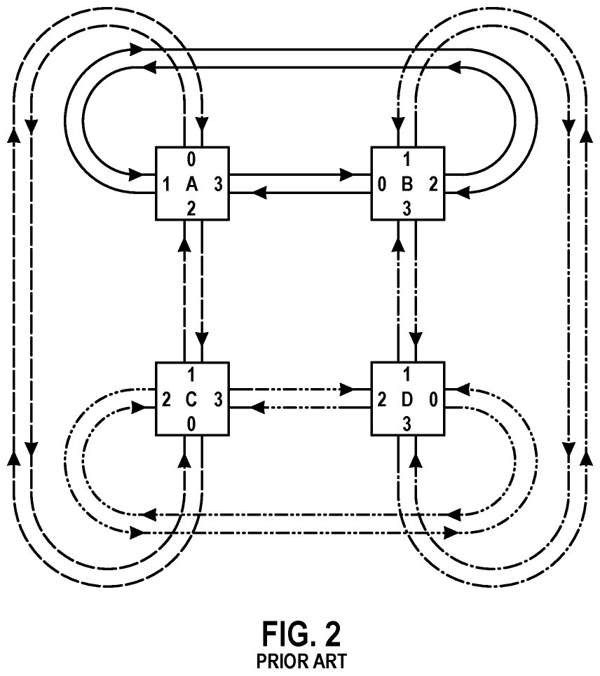

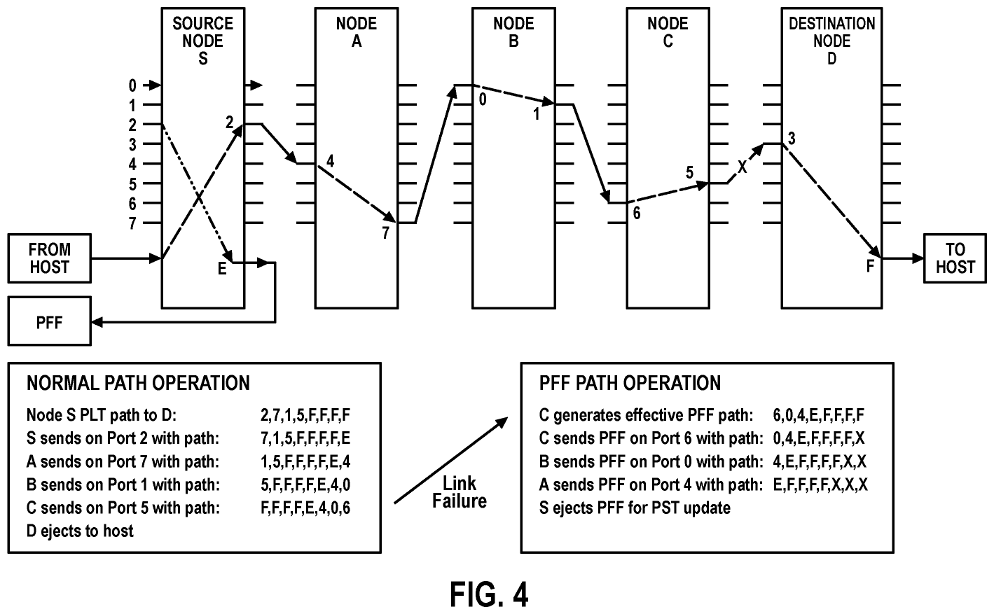

A path rotation function may be employed at each hop in the path to produce the reverse path back to the source node without requiring a path lookup function to generate the PFF flit. FIG. 4 provides a useful example to assist in explaining the preferred method, in which source node S sends flits to destination node D using a path through intermediate nodes A, B and C. Note that as explained previously in reference to FIG. 2, the paths will be calculated using the known network topology and port assignments using point-to-point links. At node S, let's assume a path selection function selected a path that is listed in the Path Lookup Table (PLT) as {2,7,1,5,F,F,F,F} in hexadecimal. In this example, the path is a list of 8 entries, each of which is either: a port number to exit to forward the flit to the next node along the path (i.e. the numbers “2, 7, 1, and 5” in this example, representing the exit ports to be used); an indication to the switch to consume the packet in the current node (i.e. the value “F” in this example, which will initially populate the remaining fields); an input port number that the flit entered in a given node that is used to create the reverse path if needed, as further explained below; an indication to the switch that the flit was forwarded from the source node (i.e. the value “E” in this example); or an indication that the PFF processing function has been initiated (i.e. the value “X” in this example) due to a link or node failure. These various entry possibilities are explained more fully below as the example in FIG. 4 is explained. In this example, all paths have a fixed length of 8 elements, although any number is possible in a given implementation (e.g. large interconnects having paths with more than 7 hops would require the use of more elements). This exit port format for the path allows simple hardware switching at each node in a direct interconnect network.

In the operation of this example, the source node S will use the first path element, i.e. “2”, as the exit port and send the Head Flit (HF) with a new path of {7,1,5,F,F,F,F,E}. This is created by consuming the first element, shifting the others forward, and appending a special value, e.g. “E” (0×E), to the end of the 8 entry list to denote that the flit was forwarded from the source node. This special value (e.g. “E”) is important when a reverse path must be used to send a PFF back to the source node, as explained below.

In the example at FIG. 4, the node input port numbers shown are merely examples and arbitrary to demonstrate the functionality, but in a real system would be a function of the network topology. At node A, in this example the Head Flit (HF) enters through port 4, and the first element in the path indicates that the exit port will be 7, so node A then sends the Head Flit (HF) onwards from exit port 7 with a new path value of {1,5,F,F,F,F,E,4}. In general, at an intermediate node the first element in the path is consumed and removed, the other elements in the path are shifted forwards, and the current input port value is appended to the end (in this case input port “4”). As will be apparent from the example at FIG. 4, appending the current input port is important for generating the reverse path should there be a link or node failure. Note that in a direct interconnect network an exit port from a node may be connected to any input port number on its neighboring nodes, depending on the topology and the node positions.

In normal operation, as shown in the left column of FIG. 4, if there was no link or node failure this process would continue with flits forwarded via intermediate nodes B and C, and when the Head Flit enters the destination node D the first element in the path will be an 0×F value indicating that this is indeed the destination (i.e. the flit will not be further forwarded to other intermediate nodes). Specifically, in the example shown in the left column of FIG. 4, the path at the input to D has become {F,F,F,F,E,4,0,6} so the flit would therefore be processed accordingly.

If, however, the link from node C port 5 to node D port 3 has failed, for example, then node C will generate a Path Failure Flit (PFF) to send to source node S to signal this failure. The PFF path operation from such an example failure is shown in the right column of FIG. 3. In this respect, node C can rapidly construct a path for the PFF to source node S from the original path as modified during normal path processing by simply reversing the order of the elements. For instance, at node C the incoming path through input port 6 was {5,F,F,F,F,E,4,0}, and the normal outgoing path would have normally been {F,F,F,F,E,4,0,6} without a failure, so the reverse path back to node S is {6,0,4,E,F,F,F,F}. As the reverse path is used and the intermediate nodes are traversed, the first element is again consumed, but this time a value, e.g. “X”, is appended to the list indicating PFF functionality has been initiated (i.e. it is not necessary to append the input port value on the reverse path).

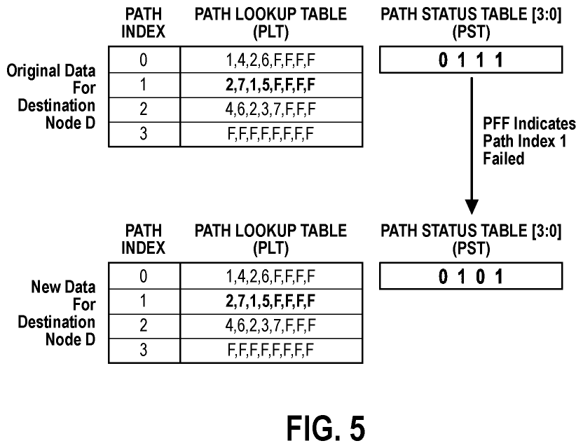

When the PFF reaches source node S it will be extracted for processing, since the first path element will have the value “E” (0×E). Metadata from the PFF will then be used to update the Path Status Table in hardware with a read-modify-write operation known to persons skilled in the art to change the particular path status to invalid due to the link/node failure along the path. Example PLT and PST data for node D in source node S are provided in FIG. 5, which relates to the example provided at FIG. 4. In this example, a value of “1” in a PST bit indicates that the corresponding path index value in the PLT contains a valid path. Originally there were three valid paths in the tables for destination node D, and path index 1 was selected (as shown in FIG. 4). However, since this path failed, the PFF will indicate the path at path index 1 for node D failed, and bit 1 in the PST (which corresponds to path index 1 in the PLT) will accordingly be cleared, meaning the path will not be selected again for packet routing until the invalid signal is modified.

This mechanism provides a method of rapidly signaling link/node failures back to source nodes without requiring table lookups, and reduces the number of packets lost during transmission by removing unavailable paths from selection and allowing for the selection of alternate paths for network traffic.

The skilled person would appreciate that in another embodiment of this mechanism, all or a portion of paths involving the failed link/node for other source/destination pairs may be set to unavailable/invalid in other PSTs as a result of the failure until the invalid signal is accordingly modified. This could minimize the number of PFFs that need to be generated and routed to remove problematic paths from the interconnect network until remedied.

In addition to rapid hardware processing by updating the PST, the software processes on the source node receiving the PFF may also be informed of the change in path status, using well known methods such as interrupts or status register polling. This may optionally trigger the software into updating the PLT and PST, for example by replacing the failed path with an additional alternate path to the destination.

In terms of deployment, in one embodiment the methods described herein may be used in association with a direct interconnect network, such as, for example, those implemented in accordance with U.S. Pat. Nos. 9,965,429 and 10,303,640 to Rockport Networks Inc., the disclosures of which are incorporated in their entirety herein by reference. U.S. Pat. Nos. 9,965,429 and 10,303,640 describe systems that provide for the easy deployment of direct interconnect network topologies and disclose a novel method for managing the wiring and growth of direct interconnect networks implemented on torus or higher radix interconnect structures.

In another preferred embodiment, the methods disclosed herein may be used in association with devices that interconnect nodes in a direct interconnect network (i.e. shuffles) as described in International PCT Publication No. WO 2022/096927 A1 to Rockport Networks Inc., the disclosure of which is incorporated in its entirety herein by reference. The shuffles described therein are novel optical interconnect devices capable of providing the direct interconnection of nodes in various topologies as desired (including torus, dragonfly, slim fly, and other higher radix topologies for instance) by connecting fiber paths from a node(s) to fiber paths of other node(s) within an enclosure to create optical channels between the nodes. This assists in optimizing networks by moving the switching function to the endpoints. The optical paths in the shuffles of International PCT Publication No. WO 2022/096927 A1 are pre-determined to create the direct interconnect structure of choice, and the internal connections are preferably optimized such that when nodes are connected to a shuffle in a predetermined manner an optimal direct interconnect network is created during build-out.

The nodes themselves may potentially be any number of different devices, including but not limited to processing units, memory modules, I/O modules, PCIe cards, network interface cards (NICs), PCs, laptops, mobile phones, servers (e.g. application servers, database servers, file servers, game servers, web servers, etc.), or any other device that is capable of creating, receiving, or transmitting information over a network. As an example, in one preferred embodiment, the node may be a network card, such as a Rockport RO6100 Network Card, as described in International PCT Publication No. WO 2022/096927 A1. Such network cards are installed in servers, but use no server resources (CPU, memory, and storage) other than power, and appear to be an industry-standard Ethernet NIC to the Linux operating system. Each Rockport RO6100 Network Card supports an embedded 400 Gbps switch (twelve 25 Gbps network links; 100 Gbps host bandwidth) and contains software that implements the switchless network over the shuffle topology (see e.g. the methods of routing packets in U.S. Pat. Nos. 10,142,219 and 10,693,767 to Rockport Networks Inc., the disclosures of which are incorporated in their entirety herein by reference).

Although specific embodiments of the invention have been described, it will be apparent to one skilled in the art that variations and modifications to the embodiments may be made within the scope of the following claims.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention is not limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Thus the scope of the invention should be determined by the appended claims and their legal equivalents, and not by the examples given.

We claim:

1. A method for signaling link or node failure to a source node when routing packets between the source node and a destination node in a direct interconnect network comprising the steps of:
(i) determining one or more paths between the source node and the destination node in the direct interconnect network and recording said paths in a path lookup table, said one or more paths in the path lookup table comprising a list of elements, namely a sequence of exit port numbers for nodes included in the one or more paths as well as a terminator marker indicating the end of the path to denote the destination node;
(ii) providing a path status table that denotes, for each of the one or more paths in the path lookup table, whether said path is available or unavailable for routing packets between the source node and destination node;
(iii) selecting a path denoted as available in the path status table in order to route a packet along said path between the source node and destination node;
(iv) at the source node, formatting the packet into one or more flits, said one or more flits comprising a head flit that includes an amended list of elements for the selected path, said amended list of elements created by performing a shift and append function to the list of elements, wherein a first element from the list of elements denoting an exit port in the source node is removed and a unique source node marker is appended to an opposite end of the list of elements,
(v) commencing routing the one or more flits from the exit port in the source node to an input port in a next node along the selected path, namely from the exit port in the source node corresponding to the first element in the list of elements,
(vi) at the next node along the selected path and upon receipt of the head flit,
if the first element in the amended list of elements comprises an exit port number, then performing a shift and append function to the amended list of elements in the head flit, wherein the first element is removed from the amended list of elements and the input port to said next node is appended to the opposite end of the amended list of elements, and continuing routing the one or more flits from the exit port in said next node in accordance with the list of elements to a further next node in the selected path, and repeating step (vi), or
if a link or node failure is detected, then generating a path failure flit to signal path failure back to the source node, said path failure flit including a source node pathway comprising a sequence of exit port numbers for nodes in the selected path back to the source node that is the amended list of elements in reverse, routing said path failure flit back to the source node, and updating the selected path in the path status table as unavailable, or
if the first element in the amended list of elements comprises the terminator marker denoting the destination node, then processing the one or more flits.

2. A direct interconnect network comprising a plurality of nodes, wherein one or more of said nodes comprise:
(i) a path lookup table comprising a list of paths to each destination node in the plurality of nodes, wherein the paths are represented as a sequence of exit port indicators for those nodes in each path in the list of paths;
(ii) a path status table advising whether each path in the list of paths is available or unavailable for packet transmission;
(iii) a path selection function for determining the path on which each packet will be sent, chosen from the available paths listed in the path status table;
(iv) a packet to flit function for transforming each packet into one or more flits, said one or more flits comprising a head flit that includes the path to the destination node, said path being updatable during flit transmission to create a reverse path if needed upon link failure detection;
(v) a flit forwarding function for transmitting the one or more flits between nodes along the path to the destination node;
(vi) output link failure detection for assessing whether flit transmission is possible from a given node in the path to the destination node;
(vii) a path failure flit generator for creating a control flit to be transmitted to a source node using the reverse path upon link failure detection;
(viii) a path failure flit extraction function to extract the destination node and path index information upon receipt of the control flit; and
(ix) a path status update function to update the path status table as necessary.

3. The direct interconnect network of claim 2, wherein the paths are represented as the sequence of exit port indicators for those nodes in each path in the list of paths and a terminator marker indicating the end of the path to denote the destination node.

4. The direct interconnect network of claim 2, wherein the reverse path includes a sequence of input port numbers for nodes in the path to the destination node.
